(19) United States
(12) Patent Application Publication
(10) Pub. No.: US 2008/0018884 A1
(43) Pub. Date: Jan. 24, 2008

(54) Intrusion Detection in Optical Fiber Networks

(76) Inventors: David Butler, Richarson, TX (US); Scott Thompson, Lucas, TX (US); Lev B. Sofman, Allen, TX (US)

Correspondence Address: ALCATEL LUCENT;INTELLECTUAL PROPERTY & STANDARDS, 3400 W. PLANO PARKWAY, MS LEGL2, PLANO, TX, 75075, US

(21) Appl. No.: 11/624,330

(22) Filed: Jan. 18, 2007

Related U.S. Application Data
(60) Provisional application No. 60/760,209, filed on Jan. 19, 2006.
(60) Provisional application No. 60/829,187, filed on Oct. 12, 2006.

(51) Int. Cl. G01N 21/00

(52) U.S. Cl. 356/73.1

(57) ABSTRACT

A method for intrusion detection in an optical fiber communication network. The method includes at a first location on an optical fiber segment, receiving a set of multiple optical signals having wavelengths differing from each other, measuring received signal power for each of the received multiple optical signals, and repeating the receiving and the measuring steps. Each optical signal in the repeated steps has same wavelength as corresponding received optical signal in the initial steps. The method further includes computing a signal power loss between each received optical signal in the repeated set and the corresponding optical signal in the initial set, fitting a curve of signal power loss vs. wavelength to the computed signal power losses using a statistical analysis, and if the signal power loss of the curve over a preselected wavelength band is at least as great as a preselected minimum loss level, providing intrusion notification.

### CROSS-REFERENCE TO RELATED APPLICATIONS

This application claims the benefit of U.S. Provisional Patent Application Ser. No. 60/760,209 filed on 19 Jan. 2006, entitled “WDM Macro-bend Detector”, and the benefit of U.S. Provisional Patent Application Ser. No. 60/829,187 filed on 12 Oct. 2006, entitled “OSC Macro-bend Detector”, which are both hereby incorporated by reference in their entirety herein.

### BACKGROUND

Fiber optic cables are used extensively in modern communication networks. This technology is popular as it has the capability of carrying large volumes of information at exceptionally fast data rates due to the large bandwidth of optical fibers. Data transmitted on fiber optic cables is relatively secure from interception by an intruder, however, means do exist which allow clandestine intrusion of fibers carrying optical signals. A part of the optical signal carrying the data may be diverted to an unauthorized detector by the relatively simple expedient of introducing a macro-bend in the fiber. This tap causes some of the optical signal carried by the fiber to exit the fiber core. A detector placed adjacent to the macro-bend can then be used to illicitly receive the data. Governmental and some corporate users are becoming increasingly concerned regarding the security of the transmitted data and requesting/requiring that systems carrying their data be equipped with some form of “intrusion detection” to counter this potential security threat.

Previous proposals for techniques to provide additional data security include (1) converting the signals carried on the optical fiber cables from amplitude shift keying (ASK) to phase shift keying (PSK), (2) using time domain reflectometry, (3) enclosing the fiber optical cable in a gas filled conduit, and (4) initiating an alarm if the signal level received at a channel wavelength of the optical fiber system drops below a specified minimum.

Converting the signals from amplitude shift keying to phase shift keying will not detect an intrusion, but it does require a more complex detector to receive the tapped signal. Thus, it has the disadvantages of added cost, as well as not being able to actually detect an intrusion.

While optical time domain reflectometers could be used to continuously or periodically carry out surveys on optical fiber cables, such activity requires additional trained personnel, as well as additional equipment, to conduct these surveys. In time domain reflectometry (TDR) a fast rise time pulse is transmitted onto the optical fiber. Reflected pulses are obtained from any discontinuity in the fiber such as a macro-bend or an improper termination. However, due to the need for repeaters/amplifiers in optical fiber networks to compensate for normal signal losses in the fiber, TDR measurements would need to be performed independently on each segment of the fiber network separated by a repeater/amplifier. Such a system is expensive to install and to operate.

Monitoring the gas pressure in a gas filled conduit enclosing a fiber optical cable could also be used to detect an intrusion. Again, however, the expense of installing and maintaining such a system would be typically prohibitive.

While monitoring the received power may not add excessive expense to a fiber optic cable system, it does not provide good security because the bend induced loss may be only a fraction of a decibel (dB), and if the alarm threshold is set sensitive enough to detect this change, numerous “false” intrusion detections will likely be indicated.

### SUMMARY

In a representative embodiment, a method for intrusion detection in an optical fiber communication network is disclosed. The method comprises adjusting transmitted signal power of an optical signal having a preselected wavelength such that at a first location on an optical fiber segment a received signal power of the optical signal is greater than a minimum detectible signal power by a preselected margin, listening for the optical signal at the first location, repeating the listening step until the listening step does not detect the optical signal for a preselected period of time, and providing intrusion notification. The optical signal was transmitted into the optical fiber segment at a second location; the optical fiber communication network comprises the optical fiber segment; and at the preselected wavelength a selected macro-bend fiber condition of the selected optical fiber type results in an additional insertion loss greater than the pre-selected margin.

In another representative embodiment, another method for intrusion detection in an optical fiber communication network is disclosed. The method comprises receiving an optical signal from an optical fiber segment of a selected optical fiber type at a first location, measuring a received signal power of the received optical signal, repeating the receiving and measuring steps, comparing the result of the initial instance of the measuring step to the result of the repeated instance of the measuring step, and if the result of the comparing step is not within preselected limits, providing intrusion notification. The received optical signal was transmitted into the optical fiber segment at a second location; the optical fiber communication network comprises the optical fiber segment; the received optical signal has a preselected wavelength; and at the preselected wavelength, a previously determined signal power loss caused by a selected macro-bend fiber condition of the selected optical fiber type is greater than the signal power loss caused by the selected macro-bend fiber condition at every wavelength carrying intrusion sensitive data on the optical fiber segment.

In yet another representative embodiment, yet another method for intrusion detection in an optical fiber communication network is disclosed. The method comprises at a first location on an optical fiber segment, receiving a set of multiple optical signals having wavelengths differing from each other, measuring received signal power for each of the received multiple optical signals, repeating the receiving and the measuring steps, computing a signal power loss between each received optical signal in the repeated set and the corresponding optical signal in the initial set, fitting a curve of signal power loss vs. wavelength to the computed signal power losses using a statistical analysis, and if the signal power loss of the curve over a preselected wavelength band is at least as great as a preselected minimum loss level, providing intrusion notification. Each optical signal in the repeated steps has same wavelength as corresponding received optical signal in the initial steps.

In still another representative embodiment, still another method for intrusion detection in an optical fiber communication network is disclosed. The method comprises at a first location on an optical fiber segment, receiving an optical signal, measuring received signal power for the received optical signal at multiple different times, for each of the measured received signal powers, computing an insertion power loss for the optical fiber segment, performing a change point analysis of the results of the step computing insertion power loss, and if the result of the step performing change point analysis meets preselected criteria, providing intrusion notification. The received optical signal was transmitted into the optical fiber segment with a preselected transmitted signal power at a second location;

Other aspects and advantages of the representative embodiments presented herein will become apparent from the following detailed description, taken in conjunction with the accompanying drawings.

### BRIEF DESCRIPTION OF THE DRAWINGS

The accompanying drawings provide visual representations which will be used to more fully describe various representative embodiments and can be used by those skilled in the art to better understand the representative embodiments disclosed and their inherent advantages. In these drawings, like reference numerals identify corresponding elements.

FIG. 1 is a drawing of an optical fiber communication network as described in various representative embodiments.

FIG. 2 is a drawing of the fiber optic communication network of FIG. 1 with macro-bends.

FIG. 3 is a drawing of a plot of signal power loss vs. wavelength for a selected optical fiber type as described in various representative embodiments.

FIG. 4 is a flow chart of a method for selecting a wavelength for intrusion detection measurements in an optical fiber communication network as described in various representative embodiments.

FIG. 5A is a flow chart of a method for intrusion detection in an optical fiber communication network as described in various representative embodiments.

FIG. 5B is a flow chart of another method for intrusion detection in an optical fiber communication network as described in various representative embodiments.

FIG. 6A is a drawing of a plot of received signal power vs. wavelength for optical signals received at various wavelengths as described in various representative embodiments.

FIG. 6B is a drawing of another plot of received signal power vs. wavelength for the optical signals received at the wavelengths of FIG. 6A.

FIG. 7 is a drawing of a plot of signal relative power loss vs. wavelength for the received optical signals of FIGS. 6A and 6B.

FIG. 8 is a flow chart of yet another method for intrusion detection in an optical fiber communication network as described in various representative embodiments.

FIG. 9 is a plot of simulated example of insertion loss vs. time for a channel.

FIG. 10 is a plot of the cumulative sum vs. time for the data of FIG. 9.

FIG. 11 is a flow chart of still another method for intrusion detection in an optical fiber communication network as described in various representative embodiments.

### DETAILED DESCRIPTION

As shown in the drawings for purposes of illustration, novel techniques are disclosed herein for the detection of macro-bend induced signal loss in optical fiber networks. Such techniques can be used to detect examination of data transmitted along the optical fiber cable by intruders or to locate macro-bends inadvertently introduced into the system during installation or maintenance activities. Previous techniques for detecting macro-bends have either been excessively expensive or have potentially resulted in the generation of numerous “false” detections.

In the following detailed description and in the several figures of the drawings, like elements are identified with like reference numerals.

As optical signals travel along an optical fiber cable, they can lose signal power due to losses caused by absorption, scattering, and/or bending in the optical fiber. Absorption is the resistive part of signal attenuation losses and is a major cause of signal loss in an optical fiber. Scattering losses are caused by the interaction of light with density fluctuations within a fiber. Bending loss is classified as either micro-bending loss or macro-bending loss according to the bend radius of curvature as compared to the diameter of the optical fiber. Micro-bends are small bends with small radii of curvatures, relative to the optical fiber diameter, in the axis of the optical fiber. They are generally introduced during manufacture of the optical fiber. On the other hand, macro-bends have larger radii of curvature relative to the fiber diameter. If the fiber is bent too sharply during installation and/or maintenance macro-bends can be the result. No significant transmission loss will result if the radius of the macro-bend is of sufficiently large radius. The definition of “sufficiently large” is dependent upon the type of the optical fiber.

A macro-bend can also be introduced intentionally in the cable by an intruder and used to divert a part of the optical signal carrying the data to an unauthorized detector. A part of the light is converted into higher-order modes part of which is radiated out of the optical fiber. This radiated light can then be detected by an intruder, thereby compromising the security of the data.

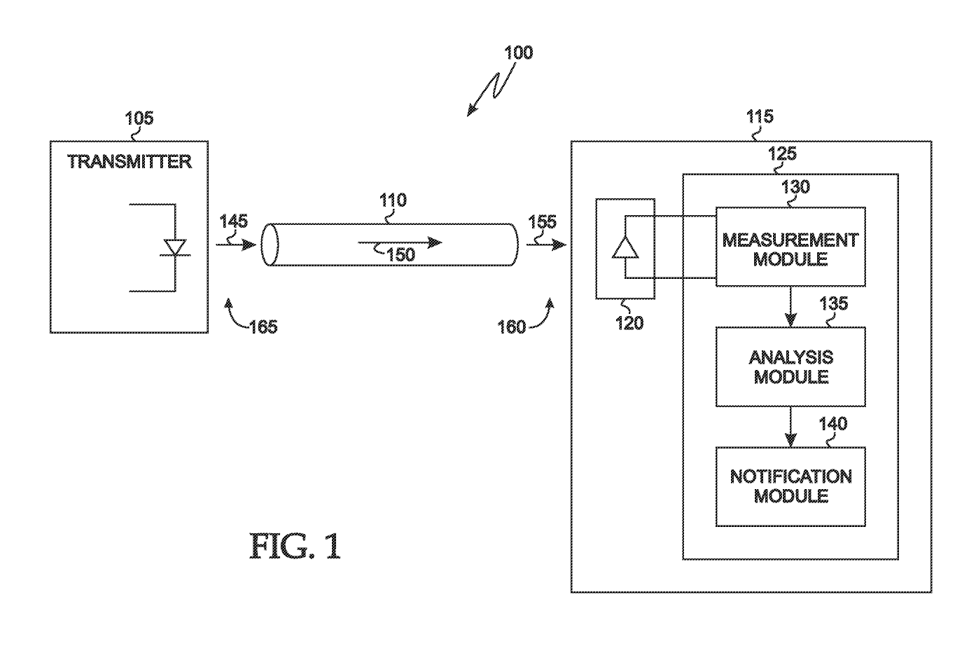

FIG. 1 is a drawing of an optical fiber communication network 100 as described in various representative embodiments. The optical fiber communication network 100 of FIG. 1 comprises an optical transmitter 105, an optical fiber segment 110, and an optical receiver 115. The optical fiber segment 110 may also be referred to herein as the optical fiber 110. The optical receiver 115 comprises a detector module 120 and a measurement system 125. The measurement system 125 comprises a measurement module 130, an analysis module 135, and an alarm module 140. In operation the optical transmitter 105 launches a transmitted optical signal 145 onto the optical fiber 110 at a second location 165, the transmitted optical signal 145 propagates through the optical fiber 110 as propagated signal 150 experiencing some loss or attenuation in signal power before it is detected at a first location 160 as received optical signal 155 by the detector module 120 in the optical receiver 115. Depending upon the context, the term “optical signal” may refer to the transmitted optical signal 145, the propagated signal 150, and/or the received optical signal 155. As described above, losses in signal power as the propagated signal 150 transits the optical fiber 110 is due to absorption, scattering, and bending in the optical fiber. Bending losses may be due to normal operation or due to macro-bends caused by unauthorized intrusions. While FIG. 1 shows only one transmitted optical signal 145 and one corresponding received optical signal 155, typically multiple optical signals which may carry data and/or supervisory information will simultaneously be transmitted from the second location 165, propagated on the optical fiber 110, and received at the first location 160.

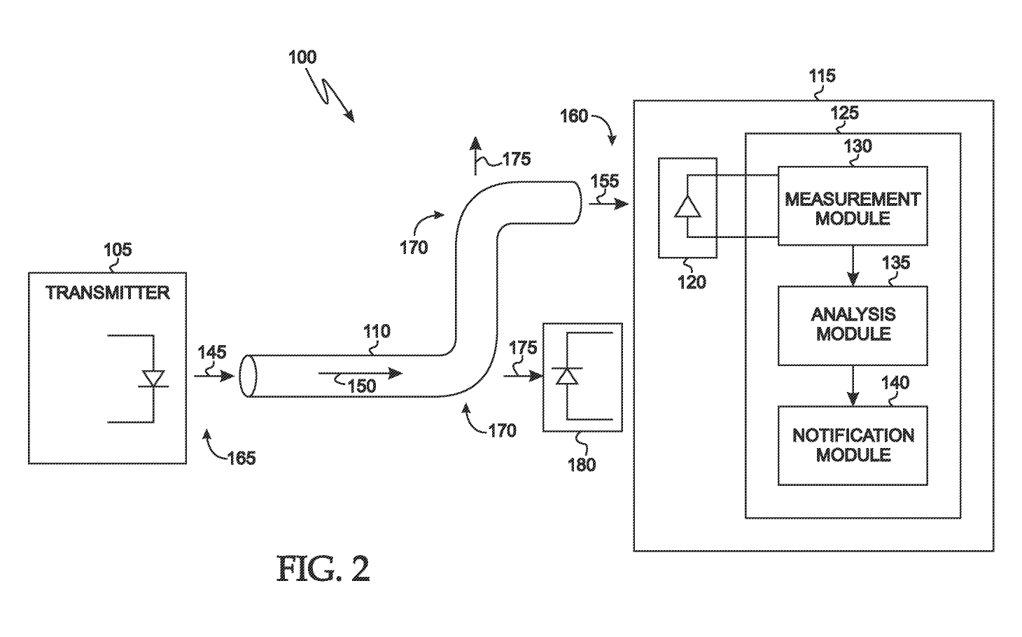

FIG. 2 is a drawing of the fiber optic communication network 100 of FIG. 1 with macro-bends 170. In FIG. 2, two macro-bends 170 have been introduced into the optical fiber segment 110 of FIG. 1 with resultant macro-bend signal 175 radiated at locations of each of the macro-bends 170. At one of the macro-bend locations, the macro-bend signal 175 radiated from the optical fiber 110 is illicitly detected by illicit receiver 180 which may also be referred to herein as intrusion system 180. As in FIG. 1, while FIG. 2 shows only one transmitted optical signal 145 and one corresponding received optical signal 155, typically multiple optical signals which may carry data and/or supervisory information will simultaneously be transmitted from the second location 165, propagated on the optical fiber 110, and received at the first location 160.

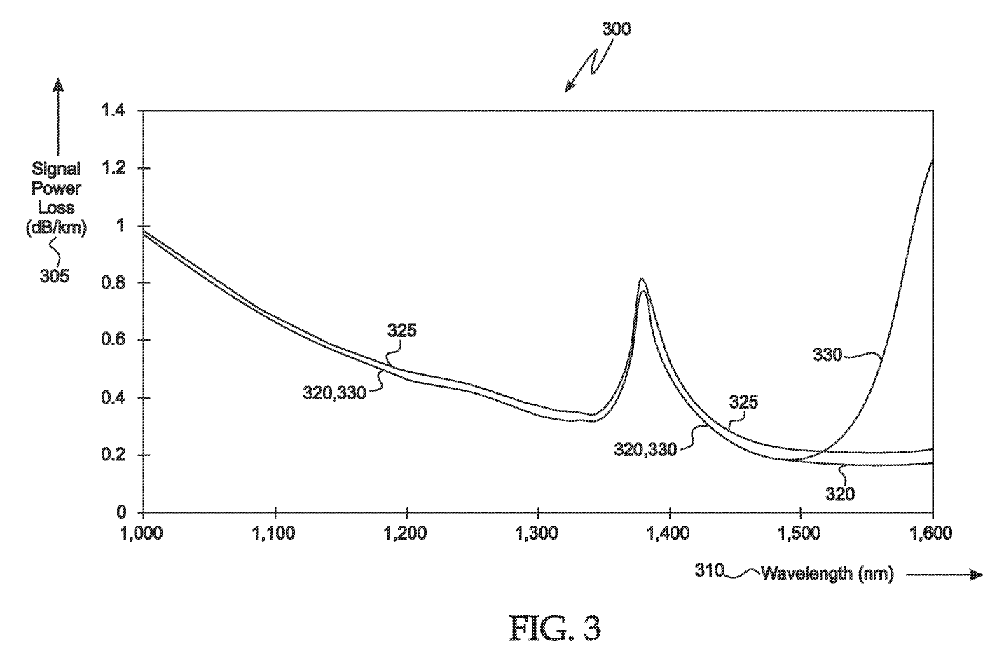

FIG. 3 is a drawing of a plot 300 of signal power loss 305 vs. wavelength 310 for a selected optical fiber type 315 as described in various representative embodiments. The signal power loss 305 may also be referred to herein as the insertion loss 305, and the wavelength 310 when carrying a data signal may also be referred to herein as the channel 310. The selected optical fiber type 315 on which the measurements of FIG. 3 are taken is not shown explicitly in the drawings but is to be inferred from FIGS. 1-3. FIG. 3 is a plot of signal power loss 305 vs. wavelength 310 for three separate conditions for the selected optical fiber type 315. These conditions are for a no bends fiber condition 320, a micro-bend fiber condition 325, and a selected macro-bend fiber condition 330.

To obtain the plots of FIG. 3, a received signal power 340 for the received optical signal 155 and a transmitted signal power 335 for the transmitted optical signal 145 are measured in a controlled test environment for each of the three conditions (the no bends fiber condition 320, the micro-bend fiber condition 325, and the selected macro-bend fiber condition 330) at various wavelengths 310 over the range of the wavelengths 310 shown in FIG. 3. If the transmitted signal power 335 is P_{T} and the corresponding received signal power 340 is P_{R}, the signal power loss 305 expressed, for example, in decibels (dB) is given by the expression 10*log₁₀[(P_{R}-P_{T})/P_{T}]. The resultant value can then be normalized to decibels per kilometer (dB/km). Neither the transmitted signal power 335 nor the received signal power 340 are shown explicitly in the drawings but are respectively a property of the transmitted optical signal 145 and a property of the received optical signal 155 as just indicated.

Note that at wavelengths 310 less than approximately 1520 nanometers (nm) for the selected optical fiber type 315 in FIG. 3, the signal power loss 305 for the no bends fiber condition 320 and the selected macro-bend fiber condition 330 are almost identical and that the signal power loss 305 for the micro-bend fiber condition 325 also differs very little from the signal power loss 305 for the no bends fiber condition 320 and for the selected macro-bend fiber condition 330. However, at wavelengths 310 greater than approximately 1520 nanometers (nm) the signal power loss 305 for the selected macro-bend fiber condition 330 begins to increasingly exceed that of the signal power loss 305 for both the no bends fiber condition 320 and the micro-bend fiber condition 325. From FIG. 3, it can be seen that at 1,550 nm, the signal power loss 305 for the selected macro-bend fiber condition 330 exceeds the signal power loss 305 for both the no bends fiber condition 320 and the micro-bend fiber condition 325 by approximately 0.2 dB/km, and at 1,600 nm, the signal power loss 305 for the selected macro-bend fiber condition 330 exceeds the signal power loss 305 for both the no bends fiber condition 320 and the micro-bend fiber condition 325 by approximately 1.0 dB/km.

Generally each optical fiber communication network 100 incorporates an optical supervisory channel (OSC) transmission with typically the preferred wavelength for the optical supervisory channel transmission being 1510 nm. But, by changing the optical supervisory channel transmission to a higher wavelength 310 the sensitivity of the optical supervisory channel transmission to macro-bends 170 is increased. Therefore a macro-bend 170 which results in a small change in insertion loss at the data transmission wavelengths and at the typical optical supervisory channel wavelength of 1510 nm would result in a significant change in the signal power loss were the optical supervisory channel transmission wavelength changed to 1550 nm or higher. False intrusion indications can be diminished, thereby. In particular, false intrusion indications can be diminished significantly by moving the optical supervisory channel transmission to a wavelength 310 of 1,600 nm and monitoring the received signal power at that wavelength. Also at such wavelengths 310, macro-bend 170 induced optical fiber taps can be more easily detected before the leaked power becomes sufficient that an intruder could gain access to data being transmitted over channels in the 1550 nm “C Band”. Since optical supervisory channel transmissions are generally present in optical fiber communication networks 100, using them to detect intrusions does not add to the complexity of the system.

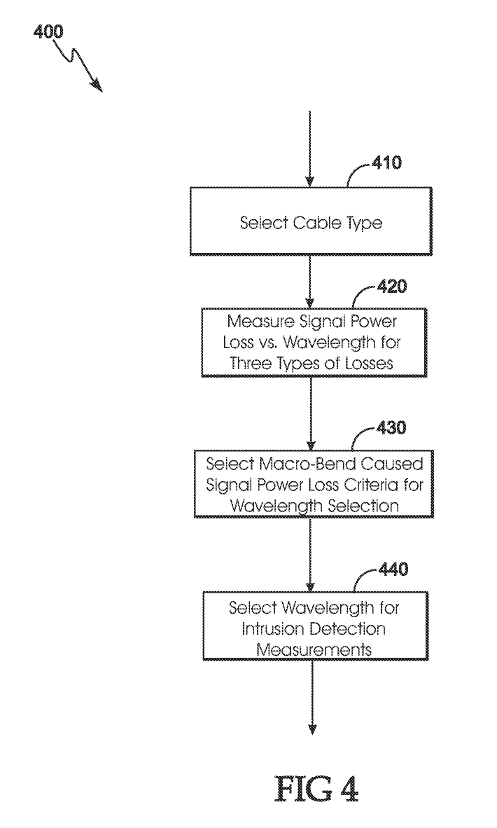

FIG. 4 is a flow chart of a method 400 for selecting a wavelength 310 for intrusion detection measurements in an optical fiber communication network 100 as described in various representative embodiments. In block 410, the optical fiber type 315 to be used in the optical fiber communication network 100 is selected. Block 410 then transfers control to block 420.

In block 420, the signal power loss 305 vs. wavelength 310 for a selected optical fiber type 315 is measured for three separate conditions for the selected optical fiber type 315. These conditions are for a no bends fiber condition 320, a micro-bend fiber condition 325, and a selected macro-bend fiber condition 330. The result of these measurements is a plot of signal power loss 305 vs. wavelength 310 for these three separate conditions an example of which is as shown in FIG. 3. Block 420 then transfers control to block 430.

In block 430, the macro-bend caused signal power loss 305 criteria for selecting the wavelength 310 to use for intrusion detection measurements is selected. The selected macro-bend caused signal power loss 305 criteria could be, for example, an additional signal power loss 305 of at least as great as 1 dB over the signal power loss 305 due to the no bends fiber condition 320 and for the micro-bend fiber condition 325. Block 430 then transfers control to block 440.

In block 440, the wavelength 310 for intrusion detection measurements in the optical fiber communication network 100 based on the macro-bend caused signal power loss 305 criteria selected in block 430. Block 440 then terminates the process.

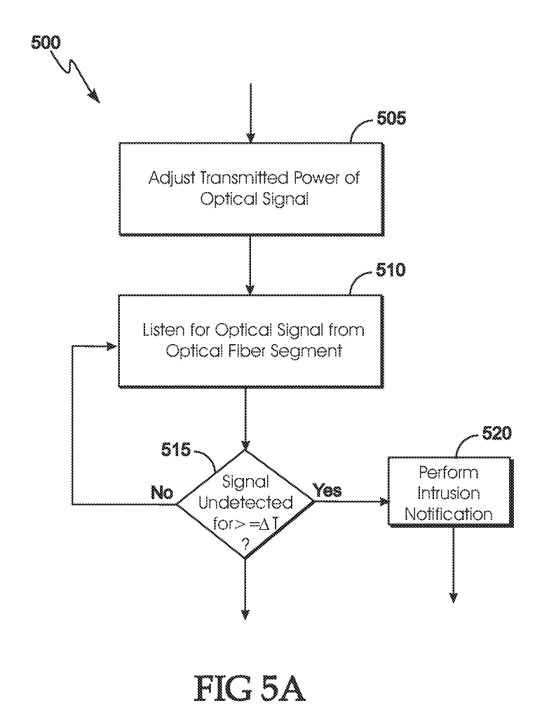

FIG. 5A is a flow chart of a method 500 for intrusion detection in an optical fiber communication network 100 as described in various representative embodiments. In block 505 a transmitted signal power 335 of an optical signal 145 having a preselected wavelength 310 is adjusted such that the detected signal power gives a preselected optical detection margin at a first location 160 on an optical fiber segment 110. The optical signal 145 was transmitted into the optical fiber segment 110 at a second location 165, and at the preselected wavelength 310 a selected macro-bend fiber condition 330 of the selected optical fiber type 315 results in at least a preselected signal power loss. Block 505 then transfers control to block 510.

In block 510, an optical receiver 115 at the first location 160 listens for the optical signal 155. Block 510 then transfers control to block 515.

In block 515, if the received optical signal 155 has been undetected for a preselected period of time, block 515 transfers control to block 520. Otherwise, block 515 transfers control back to 510. Note that the combination of blocks 510 and 515 result in the listening step of block 510 being repeated until the optical signal 155 which is to be received at the first location 160 becomes undetected for a preselected period of time.

In block 520 intrusion notification is provided. Block 520 then terminates the process.

The preselected period of time could be zero for the case of an anticipated continuous received optical signal 155 which would effectively default to the response time of the system for providing the intrusion notification, or it could be a non-zero value preselected consistent with an anticipated rate of burst for the received optical signal 155. In a representative embodiment, the received optical signal 155 could be a supervisory channel signal 155. The preselected wavelength 310 is typically at or above the upper end of the optical “C-Band” (1565 nm). The result of the adjusting step typically detects received signal power 340 of the received optical signal 155 with a margin of detection of, for example, 1 dB. At the preselected wavelength 310 a macro-bend within the fiber of a small enough radius that sufficient signal leaks from the core for an intruder to successfully intercept signals in the C-Band would result in an additional macro-bend induced loss of greater than, for example, 1 dB of the monitoring signal 155.

FIG. 5B is a flow chart of another method 550 for intrusion detection in an optical fiber communication network 100 as described in various representative embodiments. In block 555 an optical signal 145 is transmitted into an optical fiber segment 110 of a selected optical fiber type 315 at a second location 165. The optical fiber communication network 100 comprises the optical fiber segment 110; the transmitted optical signal 145 has a preselected wavelength 310 and a preselected transmitted signal power 355; and at the preselected wavelength 310 a previously determined macro-bend signal power loss 305 for a selected macro-bend fiber condition 330 of the selected optical fiber type 315 is at least as great as, for example 1 dB at wavelength 310. Block 555 then transfers control to block 560.

In block 560, the optical signal 155 is received from the optical fiber segment 110 at a first location 160. Block 560 then transfers control to block 565.

In block 565, a received signal power 340 is measured for the received optical signal 155. Block 565 then transfers control to block 570.

In block 570, the steps of blocks 555 through 565 are repeated. Block 570 then transfers control to block 575.

In block 575, the result of the initial instance of activation of block 565 is compared to the repeated instance of activation of block 565. This comparison could comprise, for example, a comparison of received signal power loss 305 of the repeated instance of block 565 to the initial instance of activation of block 565. Block 575 then transfers control to block 580.

If the result of block 575 is not within preselected limits, block 580 transfers control to block 585. Otherwise, block 580 terminates the process.

In block 585, notification of a possible intrusion is provided. Block 585 then terminates the process.

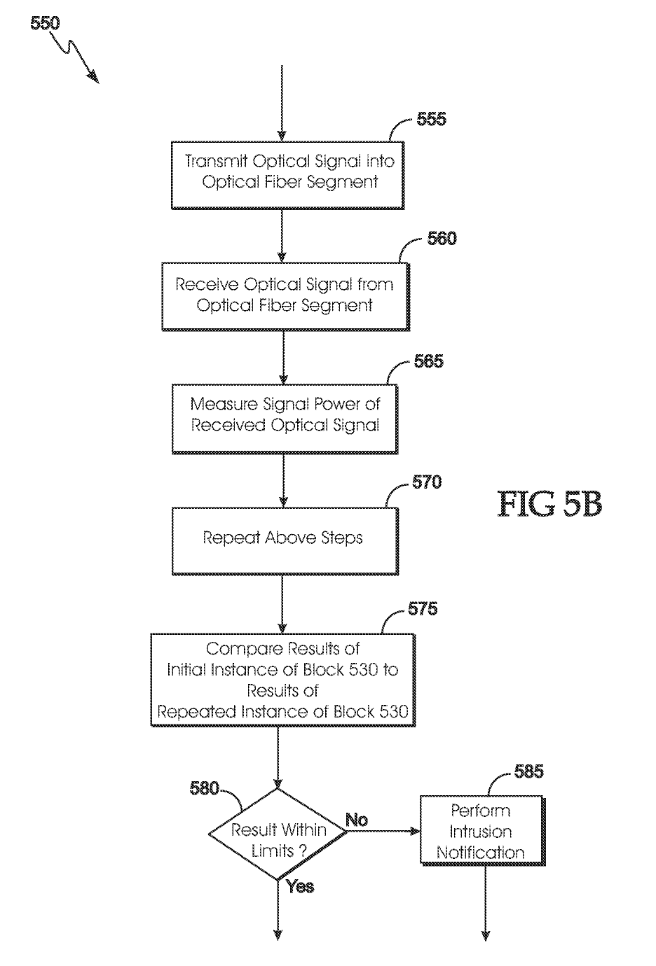

FIG. 6A is a drawing of a plot 600 of received signal power 340 vs. wavelength 310 for optical signals 155 received at various wavelengths 310 as described in various representative embodiments. FIG. 6A shows a first set of received signal powers 340 which are first, second, third, fourth, and fifth received signal powers P_{A},P_{B},P_{C},P_{D},P_{E}, at respectively first, second, third, fourth, and fifth wavelengths λ_{A},λ_{B},λ_{C},λ_{D},λ_{E}. Modern optical fiber communication networks 100 are equipped with systems for measuring the signal powers 340 at individual wavelengths 310 at a variety of locations along a system. FIG. 6A is an example of such a set of measurements at, for example, the first location 160 of FIGS. 1 and 2. These channel power monitors may be implemented in a variety of ways which includes using integrated optical spectrum analyzers (OSAs) or using signal identification using amplitude modulated “tags” associated with each wavelength 310 or channel. The various received signal powers 340 are shown in FIG. 6A as being equal to each other. However, this may or may not be the case.

FIG. 6B is a drawing of another plot 600 of received signal power 340 vs. wavelength 310 for the optical signals 155 received at the wavelengths 310 of FIG. 6A. Note that the second set of first, second, third, fourth, and fifth received signal powers P_{AA},P_{BB},P_{CC},P_{DD},P_{EE} at respectively the first, second, third, fourth, and fifth wavelengths λ_{A},λ_{B},λ_{C},λ_{D},λ_{E} shown in FIG. 6B are reduced from the first set of five received signal powers 340 shown in FIG. 6A. These reductions in received signal powers 340 could be caused, for example, by an intruder placing a macro-bend 170 in the optical fiber segment 110 so that an illicit receiver 180 appropriately placed near the macro-bend 170 can detect the macro-bend signal 175 that escapes from the optical fiber segment 110 at the macro-bend 170.

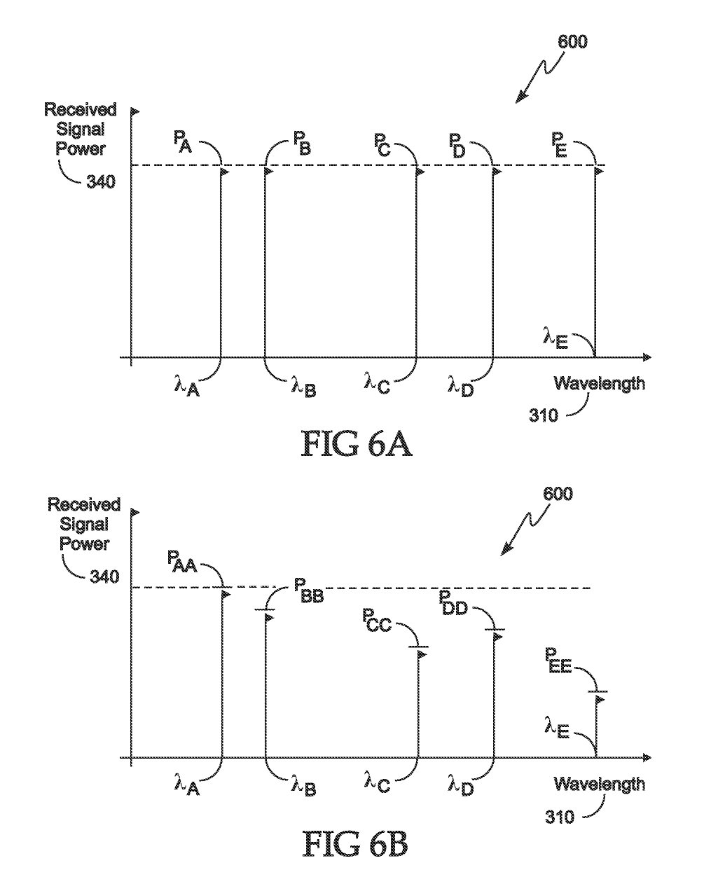

FIG. 7 is a drawing of a plot of signal relative power loss 705 vs. wavelength 310 for the received optical signals 155 of FIGS. 6A and 6B. The signal relative power losses 705 of FIG. 7 are indicated as first, second, third, fourth, and fifth signal relative power losses L_{A},L_{B},L_{C},L_{D},L_{E} and represent the power losses of the second set of first, second, third, fourth, and fifth received signal powers P_{AA},P_{BB},P_{CC},P_{DD},P_{EE} at respectively the first, second, third, fourth, and fifth wavelengths λ_{A},λ_{B},λ_{C},λ_{D},λ_{E} shown in FIG. 6B relative to the first set of first, second, third, fourth, and fifth received signal powers P_{A},P_{B},P_{C},P_{D},P_{E} at respectively the first, second, third, fourth, and fifth wavelengths λ_{A},λ_{B,λ}_{C},λ_{D},λ_{E} shown in FIG. 6A.

In various representative embodiments, the vertical axis of FIG. 7 could be in various formats. As an example, the signal relative power loss 705 could represent the first, second, third, fourth, and fifth received signal powers P_{A},P_{B},P_{C},P_{D},P_{E} of the first set subtracted from the appropriate first, second, third, fourth, or fifth received signal powers P_{AA},P_{BB},P_{CC},P_{DD},P_{EE} of the second set at respectively the first, second, third, fourth, and fifth wavelengths λ_{A},λ_{B},λ_{C},λ_{D},λ_{E}. In another example, the signal relative power loss 705 could represent the negative of the logarithm to the base 10 of each of the first, second, third, fourth, and fifth received signal powers P_{AA},P_{BB},P_{CC},P_{DD},P_{EE} of the second set divided by the appropriate first, second, third, fourth, or fifth received signal power P_{A},P_{B},P_{C},P_{D},P_{E} of the first set at respectively the first, second, third, fourth, and fifth wavelengths λ_{A},λ_{B,λ}_{C},λ_{D},λ_{E} or any other appropriate representation that indicates relative signal power loss between the first and the second sets. Either of these embodiments could be normalized to the power loss at particular wavelength 310, for example the first signal power loss P_{A} of the first set at wavelength λ_{A}. These normalized signal power losses 305 could be further normalized to losses per kilometer.

An acceptable curve 710 for a fit to the data could be a higher order polynomial curve 710, an exponential curve 710, a logarithmic curve 710, or other appropriate curve 710. Regardless of the choice of a curve 710 regression analysis or a sum of least squares method can be used to fit the chosen curve 710 to the computed set of power losses L_{A},L_{B},L_{C},L_{D},L_{E} at the respective associated wavelength λ_{A},λ_{B},λ_{C},λ_{D},λ_{E} for the second set relative to the first set. As an example, the fitting of a straight line 710 for assumed relationships are described in the following.

In a representative embodiment, a straight line 710 through the data of FIG. 7 is given by equation 1.
L=Aλ+B (Eq. 1)
The difference between the measured point Lᵢ at λᵢ and the straight line 710 as measured along the vertical axis is expressed as in Equation 2.
eᵢ=Lᵢ−L (Eq. 2)
Inserting Equation 1 into Equation 2 results in Equation 3 for the difference between the measured point Lᵢ at λᵢ and the straight line 710.
eᵢ=Lᵢ−Aλᵢ−B (Eq. 3)
The sum of the squares of the differences between the measured point Lᵢ at λᵢ and the straight line 710 as expressed in Equation 3 is given by Equation 4.

$$S = {\sum }_{i = 1}^{N} {( {L}_{i} - A {λ}_{i} - B )}^{2} \qquad ( Eq . 4 )$$

Best fit values for the constants “A” and “B” are determined by setting the partial derivative of “S” with respect to “A” and the partial derivative of “S” with respect to “B” separately equal to zero. The two resultant equations are used to solve for “A” and “B”. The partial derivative of “S” with respect to “A” is found in Equation 5 and the partial derivative of “S” with respect to “B” is found in Equation 6.

$$\begin{matrix}\frac{δ S}{\partial A} = - 2 {\sum }_{i = 1}^{N} ( {L}_{i} - A {λ}_{i} - B ) {λ}_{i} & ( Eq . 5 ) \\ \frac{δ S}{\partial B} = - 2 {\sum }_{i = 1}^{N} ( {L}_{i} - A {λ}_{i} - B ) & ( Eq . 6 )\end{matrix}$$

However, in another representative embodiment, Equation 7 describes the relationship between the signal power loss 305 and the wavelength 310 should that relationship be exponential instead of linear.
L=Be^{Aλ} (Eq. 7)
Taking the logarithm of both sides of Equation 7 results in Equation 8,
ln L=ln B+Aλ (Eq. 8)
If the vertical axis is logarithmic instead of linear, the difference between one of the points plotted on FIG. 7 and the straight line 710 is expressed as in Equation 9.
eᵢ=ln Lᵢ−ln L (Eq. 9)
Inserting Equation 8 into Equation 9 results in Equation 10 for the difference between the plotted points and the straight line 710 of FIG. 7.
eᵢ=ln Lᵢ−ln B−Aλᵢ (Eq. 10)
The sum of the squares of the differences between the measured plotted points and the straight line 710 as expressed in Equation 10 is given by Equation 5.

$$S = {\sum }_{i = 1}^{N} {( ln {L}_{i} - ln B - A {λ}_{i} )}^{2} \qquad ( Eq . 11 )$$

Best fit values for the constants “A” and “B” are determined by setting the partial derivative of “S” with respect to “A” and the partial derivative of “S” with respect to “B” separately equal to zero. Two resultant equations are used to solve for “A” and “B”. The partial derivative of “S” with respect to “A” is found in Equation 12 and the partial derivative of “S” with respect to “B” is found in Equation 13.

$$\begin{matrix}\frac{\partial S}{\partial A} = - 2 {\sum }_{i = 1}^{N} ( ln {L}_{i} - ln B - A {λ}_{i} ) {λ}_{i} & ( Eq . 12 ) \\ \frac{\partial S}{\partial B} = - \frac{2}{B} {\sum }_{i = 1}^{N} ( ln {L}_{i} - ln B - A {λ}_{i} ) & ( Eq . 13 )\end{matrix}$$

As indicated above, representative embodiments other than the above may comprise other relationships between the signal relative power losses 705 and wavelength 310. In particular, since only small changes would be expected at lower wavelengths for a macro-bend, relationships that give higher weights to the longer wavelengths may provide better curves to which to fit the measured data for macro-bend detection than the semi-logarithm curve obtained from Equation 8. Also, the sum of the squares of the differences between the measured point Lᵢ at λᵢ and the straight line 710 could alternatively be expressed as a minimum distance between the measured point Lᵢ at λᵢ and the straight line 710 rather than the minimum along the vertical or signal relative power loss 705 axis as in Equation 4.

Also shown in FIG. 7 is a wavelength band 720 bounded by a lower wavelength λ_{L} and an upper wavelength λ_{U}. A first test for whether or not to specify that an intrusion has occurred could be whether or not the signal relative power loss 705 for the fitted straight line 710 (or other selected fitted curve 710) lies totally above a preselected minimum loss level 725. If the signal relative power loss 705 for the fitted curve 710, which could be the fitted straight line 710 of FIG. 7, lies totally above a preselected minimum loss level 725 over the wavelength band 720, notification that a possible intrusion has occurred could be provided. Note that in FIG. 7, within the wavelength band 720 the curve 710 lies at or above the minimum power loss 715 which is greater than the minimum loss level 725. The lower wavelength λ_{L} may be less than, equal to, or greater than the lowest of the wavelengths 310 in the measured set of signal relative power losses 705, and the upper wavelength λ_{U} may be less than, equal to, or greater than the highest of the wavelengths 310 in the measured set of signal relative power losses 705.

A second test for whether or not to specify that an intrusion has occurred could be whether or not the quality of fit of the data to the fitted curve 710 is better than a preselected value. The term “goodness of fit” may also refer to “quality of fit” herein. One criteria for the goodness of fit of the data to the fitted curve 710 is the correlation coefficient R defined in Equation 14 wherein μ_{X} and σ_{X} are the sample mean and the sample standard deviation respectively for the variable x and wherein μ_{Y} and σ_{Y} are the sample mean and the sample standard deviation respectively for the variable y.

$$R = \frac{1}{( N - 1 )} {\sum }_{i = 1}^{N} \frac{( {x}_{i} - {μ}_{X} )}{{σ}_{X}} \frac{( {y}_{i} - {μ}_{Y} )}{{σ}_{Y}} \qquad ( Eq . 14 )$$

The maximum possible value for the correlation coefficient R is +1 which implies a perfect correlation of the data points with the fitted curve 710. In other words, all of the data points lie exactly on top of the fitted curve 710. And, the minimum possible value for the correlation coefficient R is −1 which implies the absolute non-correlation of the data points with the fitted curve 710. If the correlation coefficient R for the fitted curve 710, which could be the fitted straight line 710 of FIG. 7, has a value greater than a preselected value, notification that a possible intrusion has occurred could be provided.

In another representative embodiment, the first criteria indicated above is first considered. If the first criteria indicates an intrusion, the second criteria is considered. If the second criteria then also indicates an intrusion, notification that a possible intrusion has occurred could be provided. Other embodiments include notification of an intrusion based solely upon the first criteria and notification of an intrusion based solely upon the second criteria.

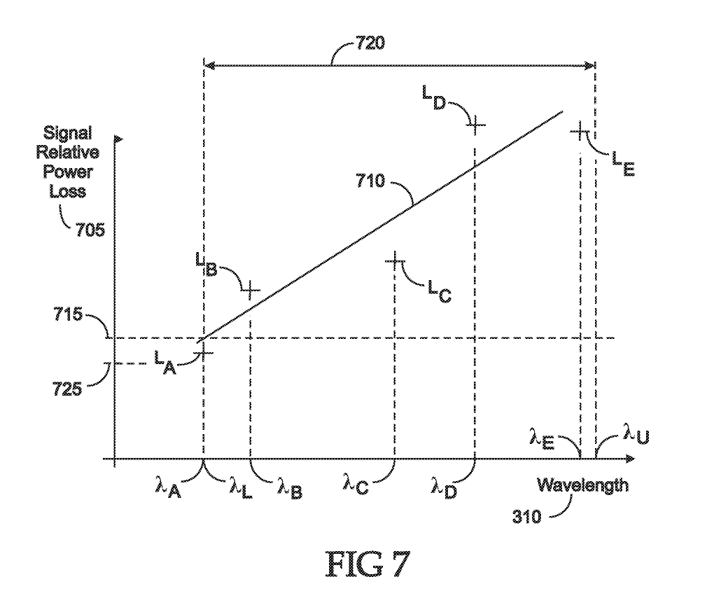

FIG. 8 is a flow chart of yet another method 800 for intrusion detection in an optical fiber communication network 100 as described in various representative embodiments. In block 810 a set of multiple transmitted optical signals 145 are transmitted into an optical fiber segment 110 of a selected optical fiber type 315 at a second location 165. The optical fiber communication network 100 comprises the optical fiber segment 110; the multiple transmitted optical signals 145 have preselected wavelengths 310 in a preselected band of wavelengths 310 and a preselected transmitted signal power 355. Block 810 then transfers control to block 820.

In block 820, the multiple received optical signals 155 are received from the optical fiber segment 110 at a first location 160. Block 820 then transfers control to block 830.

In block 830, the received signal powers 340 are measured for the set of multiple received optical signals 155. Block 830 then transfers control to block 840.

In block 840, the steps of blocks 810 through 830 are repeated for an additional set of multiple transmitted optical signals 145 and corresponding multiple received optical signals 155. As previously discussed, the first set of power measurements of the multiple received optical signals 155 could comprise first, second, third, fourth, and fifth received signal powers P_{A},P_{B},P_{C},P_{D},P_{E} at respectively the first, second, third, fourth, and fifth wavelengths λ_{A},λ_{B,λ}_{C},λ_{D},λ_{E} shown in FIG. 6A, and the second set of power measurements of the multiple received optical signals 155 could comprise first, second, third, fourth, and fifth received signal powers P_{AA},P_{BB},P_{CC},P_{DD},P_{EE} at respectively the first, second, third, fourth, and fifth wavelengths λ_{A},λ_{B},λ_{C},λ_{D},λ_{E} shown in FIG. 6B. Block 840 then transfers control to block 850.

In block 850, the multiple signal relative power losses 705 representing the second set of multiple received signal powers 340 at preselected wavelengths 310 relative to the first set of multiple received signal powers 340 at the preselected wavelengths 310 are computed. Block 850 then transfers control to block 860.

In block 860, a curve 710 is fitted to the computed multiple signal relative power losses 705 obtained in block 850. The regression analysis or the method of least mean squares could be used to fit the computed multiple signal relative power losses 705 to the curve 710. A method similar to that described above with FIG. 7 could be used to obtain the curve fit. The curve 710 used for an acceptable fit to the data could be a first or higher order polynomial curve 710, an exponential curve 710, a logarithmic curve 710, or other appropriate curve 710. Regardless a sum of least squares method can be used to fit the chosen curve 710 to the computed set of power losses L_{A},L_{B},L_{C},L_{D},L_{E} at the respective associated wavelength λ_{A},λ_{B},λ_{C},λ_{D},λ_{E} for the second set relative to the first set of received optical signals 155. Block 860 then transfers control to block 870.

In block 870, a minimum power loss 715 for the signal relative power loss 705 over a preselected wavelength band 720 is determined for the curve 710 obtained in block 860. Block 870 then transfers control to block 880.

If the minimum power loss 715 for the signal relative power loss 705 over a preselected wavelength band 720 as determined for the curve 710 in block 870 is greater than a preselected minimum loss level 725, block 880 transfers control to block 885. Otherwise, block 880 terminates the process.

In block 885, a value for the quality or goodness of fit of the data to the fitted curve 710. A measure of this quality of fit of the data to the fitted curve 710 could be the correlation coefficient R as defined in Equation 14. Block 885 then transfers control to block 890.

If the quality of fit of the data to the fitted curve 710 meets preselected criteria indicating that there is a sufficiently good fit of the data to the fitted curve 710, block 890 transfers control to block 895. Otherwise, block 890 terminates the process.

In block 895, notification of a possible intrusion is provided. Block 895 then terminates the process.

The received signal power 340 of a single optical channel 310 transmitted across an optical fiber 110 varies with time in an apparently random fashion. This variation is primarily due to polarization dependent loss variations. In installed systems, these channel power fluctuations may be significantly greater than the increased loss associated with a clandestine macro-bend tap and may obscure the loss of a macro-bend inadvertently introduced during maintenance. In the presence of the background “noise” resulting from the polarization dependency, it is difficult to determine when these events occur. In another representative embodiment, a Bayseian statistical approach offers a method of detecting macro-bends by inference from historical data in the presence of noise.

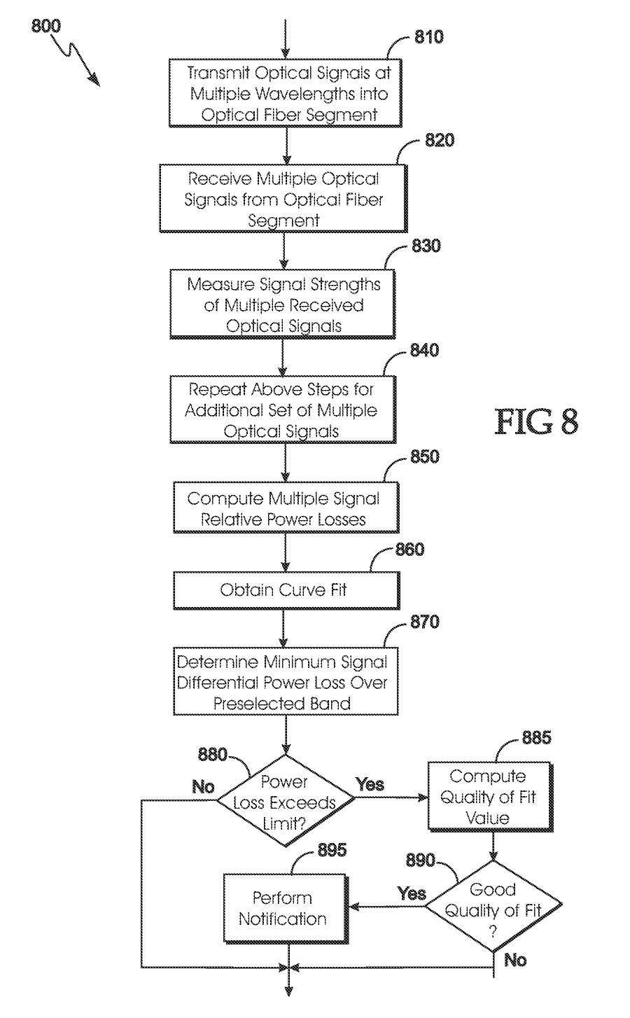

FIG. 9 is a plot of simulated example of insertion loss 305 vs. time 910 for a channel 310. The mean insertion loss 305 for the channel 310 of FIG. 9 is 20 dB. The insertion loss 305 is determined by subtracting the received signal power 340 at the end of the optical fiber segment 110 from the transmitted signal power 355 for the channel 310. In the representative example of FIG. 9, measurements could have been taken every minute over a 300 minute observation window. After 150 minutes a macro-bend 170 resulting in a 0.3 dB insertion loss 305 was applied.

Detection of the small macro-bend 170 caused increase in insertion loss 305 indicated in FIG. 9 cannot be achieved by setting a control limit threshold at 20.3 dB since the apparently random fluctuations in insertion loss 305 mask the macro-bend induced loss. Bayseian statistics may be used to detect the macro-bend 170 by performing a change-point analysis. The first step in performing a change-point analysis is to calculate the cumulative sum Sₙ for each of the N measurements as follows,
Sₙ=Sₙ₋₁+(Pₙ−P_{avg}) (Eq. 15)
where Pₙ is the insertion loss 305 and P_{avg} is the average insertion loss 305. The cumulative sum Sₙ for the initial measurement is set equal to zero, i.e., S₀=0.

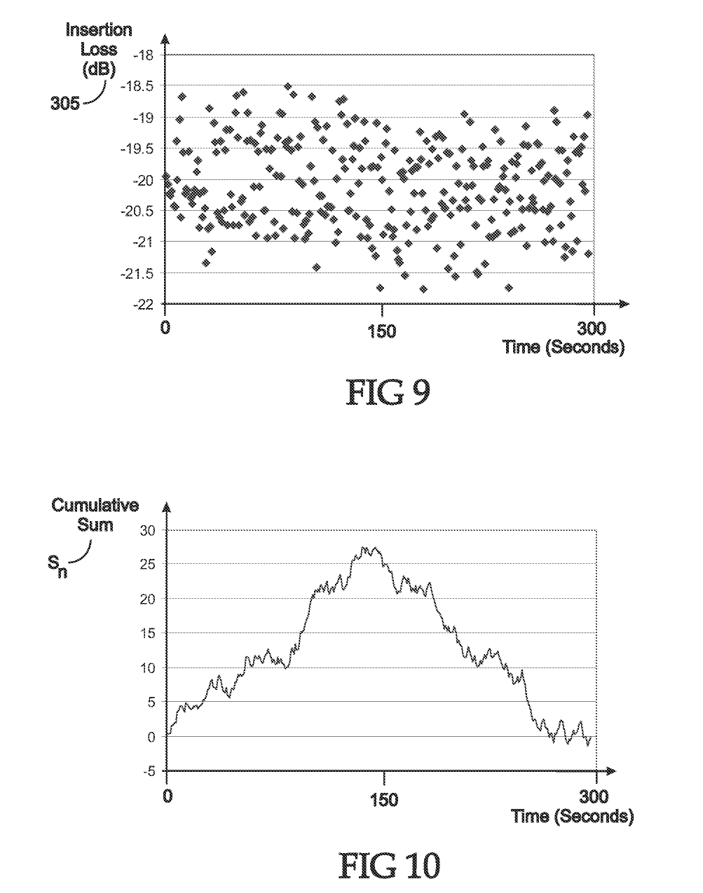

FIG. 10 is a plot of the cumulative sum Sₙ vs. time 910 for the data of FIG. 9. Since S₀ is set to zero, Sₙ at t=300 minutes will also be zero. The period of time 910 when the insertion losses 305 are below the average insertion loss P_{avg} results in a positive slope while the period of time 910 when the insertion losses 305 are below the average insertion loss P_{avg} results in a negative slope. Smoothing the curve and detecting a change in the sign of the slope of the cumulative sum Sₙ vs. time 910 curve, therefore, indicates a shift in the average insertion loss. Note that in FIG. 10, the macro-bend added at t=150 minutes has resulted in a reversal of the slope of the cumulative sum Sₙ vs. time 910 curve.

To further reduce false macro-bend 170 indications due to random fluctuations in insertion loss 305 a confidence level may be calculated. One way of calculating a confidence level from the data of FIGS. 9 and 10 is using a bootstrapping technique as in the following discussion. First an estimate is made of the magnitude of the change S_{diff} where,

$$\begin{matrix}{S}_{diff} = {S}_{max} - {S}_{min} \\ and & ( Eq . 16 ) \\ {S}_{max} = {max}_{i = 0 … n} {S}_{i} & ( Eq . 17 ) \\ {S}_{min} = {max}_{i = 0 … n} {S}_{i} & ( Eq . 18 )\end{matrix}$$

Then, a “bootstrap” sample of all n readings of the original insertion losses is generated by randomly reordering them:
P⁰₁, P⁰₂, P⁰₃, . . . P⁰ₙ
The bootstrap sample cumulative sum is calculated in a manner similar to that of Equation 15.
S⁰₁, S⁰₂, S⁰₃, . . . S⁰ₙ
The minimum, maximum and difference of the bootstrap cumulative sum is calculated:
S⁰ₘₐₓ, S⁰ₘᵢₙ and S⁰_{diff}
If S_{diff}>S⁰_{diff} then the insertion losses 305 in their original order suggest that a change occurred more strongly than the data in a random order does. Repeating the bootstrap process a large number of times a confidence level can be generated from,

$$ConfidenceLevel = 100 \frac{X}{N} \% \qquad ( Eq . 19 )$$

where X is the number of bootstrap reordered samples which resulted in S_{diff}>S⁰_{diff} and N is the number of samples where S_{diff}<S⁰_{diff}. Using this technique a confidence level threshold may be predetermined, and a warning of a possible macro-bend raised when this threshold is exceeded.

This technique may be further extended to include analysis of indicated insertion losses 305 from multiple channels. Since a macro-bend 170 is known to generate a wavelength dependent insertion loss 305 a simple way of using change-point analysis on multiple wavelength systems would be to monitor the insertion loss of each channel individually, perform the cumulative sum calculations and bootstrapping on each of the sets of channel insertion losses 305. The significance of each channel could be appropriately weighted by its wavelength. In particular, channels having the longer wavelengths 310 could be given a greater weight than those channels at shorter wavelengths 310.

Alternatively an aggregate cumulative sum may be generated from all of the individual sets of channel insertion loss data:

$${S}_{n}^{′} = {S}_{n - 1}^{′} + {\sum }_{i = 1}^{i = j} ( {P}_{n}^{i} - {P}_{avg}^{i} ) \qquad ( Eq . 20 )$$

where j is the channel number. Again a bootstrap technique which reorders the data randomly within each channel set may be used to establish a confidence level that the insertion loss had changed.

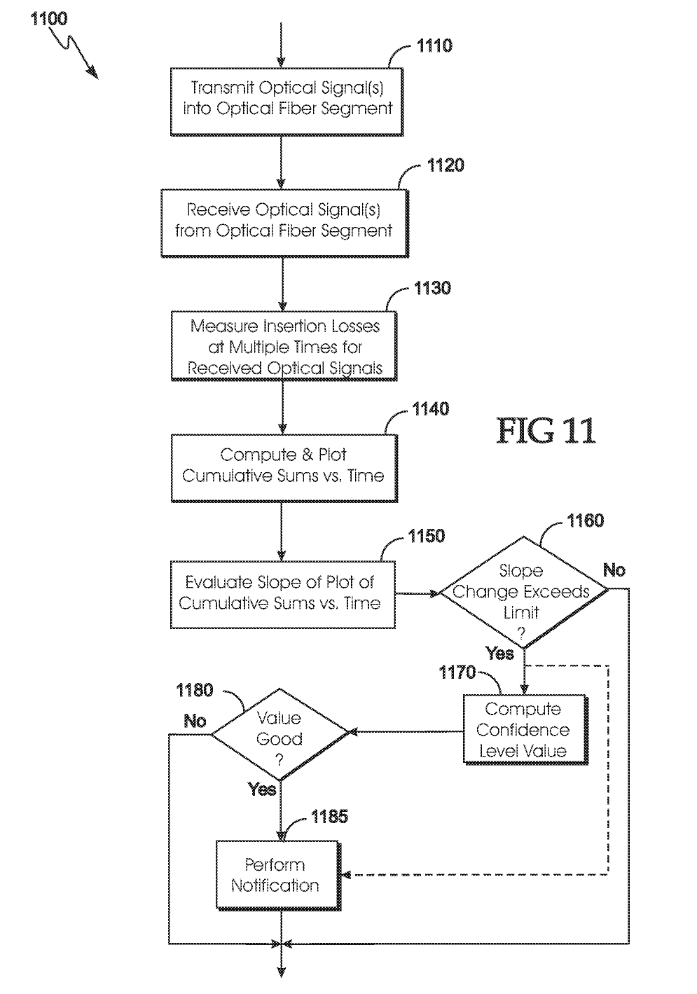

FIG. 11 is a flow chart of still another method 1100 for intrusion detection in an optical fiber communication network 100 as described in various representative embodiments. In block 1110 transmitted optical signal(s) 145 are transmitted into an optical fiber segment 110 of a selected optical fiber type 315 at a second location 165. Block 1110 then transfers control to block 1120.

In block 1120, the received optical signal(s) 155 is/are received from the optical fiber segment 110 at a first location 160. Block 1120 then transfers control to block 1130.

In block 1130, the insertion losses 305 are measured for the received optical signal(s) 155. Block 1130 then transfers control to block 1140.

In block 1140, the cumulative sums Sₙ as given, for example, in Equation 15 and 20 is computed and plotted vs. time. Block 1140 then transfers control to block 1150.

In block 1150, the slope of the plot of cumulative sums Sₙ vs. time is evaluated. Block 1150 then transfers control to block 1160.

In block 1160, if the slope change vs. time exceeds a preselected limit, block 1160 transfers control to block 1170, or in an alternative path as shown by the dashed line in FIG. 11, block 1160 can instead transfer control to block 1185. Otherwise, block 1160 then transfers control to block 1110 to repeat the above process.

In block 1170, a confidence level value as, for example, given by Equation 19 is computed. Block 1170 then transfers control to block 1180.

In block 1180, if the value of the confidence level exceeds a preselected value, block 1180 transfers control to block 1185. Otherwise, block 1180 transfers control to block 1110 to repeat the above process.

In block 1185, notification of a possible intrusion is provided. Block 1185 then transfers control to block 1110 to repeat the above process.

As is the case, in many data-processing products, the systems described above may be implemented as a combination of hardware and software components. Moreover, all or part of the functionality required for use of the representative embodiments may be embodied in computer-readable media (such as floppy disks, conventional hard disks, DVDs, CD-ROMs, Flash ROMs, nonvolatile ROM, and RAM) to be used in programming an information-processing apparatus to perform in accordance with the techniques so described. The term “program storage medium” is broadly defined herein to include any kind of computer memory such as, but not limited to, floppy disks, conventional hard disks, DVDs, CD-ROMs, Flash ROMs, nonvolatile ROM, and RAM.

In representative embodiments methods are disclosed herein for the detection of macro-bend induced signal loss in optical fiber networks. Such techniques can be used to detect examination of data transmitted along the optical fiber cable by intruders or to locate macro-bends inadvertently introduced into the system during installation or maintenance activities. The present methods are compatible with currently installed optical fiber communication systems and can be implemented relatively inexpensively and can be adjusted to reduce the potential for the generation of “false” detections.

The representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A method for intrusion detection in an optical fiber communication network, comprising:
adjusting transmitted signal power of an optical signal having a preselected wavelength such that at a first location on an optical fiber segment a received signal power of the optical signal is greater than a minimum detectible signal power by a preselected margin, wherein the optical signal was transmitted into the optical fiber segment at a second location, wherein the optical fiber communication network comprises the optical fiber segment, and wherein at the preselected wavelength a selected macro-bend fiber condition of a selected optical fiber type results in an additional insertion loss greater than the pre-selected margin;
listening for the optical signal at the first location;
repeating the listening step until the listening step does not detect the optical signal for a preselected period of time; and
providing intrusion notification.

2. The method as recited in claim 1, wherein the preselected period of time is a response time for providing the intrusion notification.

3. The method as recited in claim 1, wherein the received optical signal is a supervisory channel signal.

4. The method as recited in claim 1, wherein the preselected wavelength is longer than each and every wavelength carrying intrusion sensitive data on the optical fiber segment.

5. The method as recited in claim 1, wherein at the preselected wavelength the selected macro-bend fiber condition of the selected optical fiber type results in a signal power loss greater than the signal power loss caused by the selected macro-bend fiber condition at every wavelength carrying intrusion sensitive data on the optical fiber segment.

6. A method for intrusion detection in an optical fiber communication network, comprising:
receiving an optical signal from an optical fiber segment of a selected optical fiber type at a first location, wherein the received optical signal was transmitted into the optical fiber segment at a second location, wherein the optical fiber communication network comprises the optical fiber segment, wherein the received optical signal has a preselected wavelength, and wherein at the preselected wavelength, a previously determined signal power loss caused by a selected macro-bend fiber condition of the selected optical fiber type is greater than the signal power loss caused by the selected macro-bend fiber condition at every wavelength carrying intrusion sensitive data on the optical fiber segment;
measuring a received signal power of the received optical signal;
repeating the receiving and measuring steps;
comparing the result of the initial instance of the measuring step to the result of the repeated instance of the measuring step; and
if the result of the comparing step is not within preselected limits, providing intrusion notification.

7. The method as recited in claim 6, wherein the received optical signals are supervisory channel signals.

8. The method as recited in claim 6, wherein the preselected wavelength is longer than each and every wavelength carrying intrusion sensitive data on the optical fiber segment.

9. A method for intrusion detection in an optical fiber communication network, comprising:
at a first location on an optical fiber segment, receiving a set of multiple optical signals having wavelengths differing from each other;
measuring received signal power for each of the received multiple optical signals;
repeating the receiving and the measuring steps, wherein each optical signal in the repeated steps has same wavelength as corresponding received optical signal in the initial steps;
computing a signal power loss between each received optical signal in the repeated set and the corresponding optical signal in the initial set;
fitting a curve of signal power loss vs. wavelength to the computed signal power losses using a statistical analysis; and
if the signal power loss of the curve over a preselected wavelength band is at least as great as a preselected minimum loss level, providing intrusion notification.

10. The method as recited in claim 9, wherein performing the step providing intrusion notification is further conditional upon the result of a step computing a goodness of fit value for the computed values of signal power loss to the curve being at least as great as a preselected value.

11. The method as recited in claim 9, wherein the statistical analysis used is regression analysis.

12. The method as recited in claim 9, wherein the computed goodness of fit value is correlation coefficient of the computed signal power loss to the fitted curve.

13. A method for intrusion detection in an optical fiber communication network, comprising:
at a first location on an optical fiber segment, receiving an optical signal, wherein the received optical signal was transmitted into the optical fiber segment with a preselected transmitted signal power at a second location;
measuring received signal power for the received optical signal at multiple different times;
for each of the measured received signal powers, computing an insertion power loss for the optical fiber segment,
performing a change point analysis of the results of the step computing insertion power loss; and
if the result of the step performing change point analysis meets preselected criteria, providing intrusion notification.

14. The method as recited in claim 13, wherein performing the step providing intrusion notification is further conditional upon the result of a step computing a confidence level for the result of the step performing change point analysis.

15. The method as recited in claim 14, wherein the confidence level is obtained by a bootstrapping technique.

16. The method as recited in claim 13, wherein the step performing change point analysis further comprises:
computing cumulative sums for the results of the step computing insertion power loss;
plotting computed cumulative sums vs. time; and
evaluating slope of plot of cumulative sums vs. time.

17. The method as recited in claim 13, wherein the steps prior to the step providing intrusion notification are repeated for each of multiple received optical signals and wherein performing the step providing intrusion notification is further conditional upon the results of each step performing change point analysis.

18. The method as recited in claim 17, wherein performing the step providing intrusion notification is further conditional upon the result of a step computing a confidence level for the combined results of the steps performing change point analysis for each of the multiple received optical signals.
